(19) United States
(12) Patent Application Publication
(10) Pub. No.: US 2023/0353418 A1
(43) Pub. Date: Nov. 2, 2023

(54) LOW LATENCY SYSTEMS AND METHODS FOR VEHICLE COMMUNICATIONS NETWORK ARCHITECTURE USING POINT OF USE CONTROLLER

(71) Applicant: APTERA MOTORS CORP., San Diego, CA (US)

(72) Inventor: Eric LIGHTHART, San Diego, CA (US)

(73) Assignee: APTERA MOTORS CORP., San Diego, CA (US)

(21) Appl. No.: 17/733,454

(22) Filed: Apr. 29, 2022

(51) Int. Cl. H04L 12/40; H04L 67/12

(52) U.S. Cl. CPC H04L 12/40032; H04L 67/12; H04L 2012/40234

(57) ABSTRACT

A LIN communication system may include a gateway module coupled to one or more LIN strings, each LIN string including one or more hardware-only point-of-use controllers (PoUC) and/or one or more programmable point-of-use controllers (PoUC). Each PoUC may be tailored to a plurality of end devices, and centrally-disposed with respect to the same. The system represents an optimized arrangement that minimizes weight, cost, and complexity of the system, while providing optimized functionality in terms of processing power, bandwidth, and the like, to achieve only that which is needed to control the vehicle. The system employs a scheduler that may interleave I/O and diagnostic messages on the LIN-protocol bus at the PoUC level that may reduce unused bandwidth. This system may be particularly adapted for use in an electric vehicle having on-board solar panels, wherein the weight of system components is a dominating factor in the vehicle design.

### FIELD OF THE INVENTION

The invention relates generally to vehicle communications network architecture. In particular, the invention relates to vehicle communications network architecture systems and methods using one or more point-of-use controllers and a scheduler that interleaves the I/O and diagnostic messages on the LIN-protocol bus at the PoUC level to achieve a design that minimizes weight, cost, complexity, and reduces unused bandwidth across the entire vehicle on the LIN bus.

### BACKGROUND

Vehicle communication network architecture refers to how sensors and processors distributed throughout a vehicle connect and interact with one another. Communication networks of this sort have become, and will continue to be, increasingly complex due to a variety of external factors that impact the automotive industry. These external factors provide, to a large extent, the motivation for vehicle developers and manufacturers to continue to innovate vehicle systems' design; they include consumer demands, road safety demands, and environmental impact demands. For one, consumers desire increasingly complex capabilities of their vehicles. Consumers desire, for example, increasingly complex infotainment systems, such as those that seamlessly integrate with external devices, like smart phones, for simultaneous entertainment, communication, information, navigation, and charging purposes. For another, road safety considerations motivate designers to incorporate increasingly complex road safety measures, like collision-avoidance, lane departure warning systems, lane change assist, semi-autonomous driving, and/or autonomous driving. And for another, environmental impact mitigation continues to drive the automotive industry to ever-increasing fuel economy standards, electric vehicle innovations, and more recently, solar-powered electric vehicle innovations. Systems that meet these increasing demands, like those exemplified here, typically require more wiring and equipment, which results in communication network designs that are heavier, take up more space, and increase the manufacturing cost and/or purchase price of the vehicle. Once the vehicle is in use, these communication network designs consume more power and are more difficult to maintain, troubleshoot, and/or modify.

In the field of electric vehicles that incorporate on-board solar panels, communication network designs present additional challenges. For example, conventional communication network designs represent added weight to the vehicle, which limits the range of the electric vehicle and its overall efficiency. As another example, conventional designs consume more power, thereby putting a higher energy demand on the batteries and solar cells, which also limits the range of the electric vehicle and its overall efficiency. And as another example, conventional designs either do not provide enough bandwidth to accommodate the additional sensors and/or electric control units (ECUs) required by demands on modern industry, or these designs provide too much bandwidth that results in excess or unused bandwidth across one or more parts of the network. This additional bandwidth equates to excess wiring and associated weight, as well as unnecessary cost and complexity.

Despite strong incentives across a variety of industries, there remains a long-felt need to reduce unused bandwidth using a scheduler that interleaves the I/O and diagnostic messages on the LIN-protocol bus for a vehicle communication network architecture that reduces weight, cost, and complexity.

### SUMMARY

The present invention advantageously addresses the aforementioned deficiencies by providing a zone-based, vehicle communication network architecture using a LIN scheduler that minimizes weight, cost, and complexity, while providing an optimized functionality in terms of processing power, bandwidth, and the like, to achieve only that which is needed to operate vehicle systems.

In another aspect of the present invention, the communication network uses a zone-based architecture that employs a lightweight, point-of-use controller (PoUC) adapted to move electronic and electrical control functions as close as practical to the devices under control (i.e., “end devices”). Each PoUC may include only what is necessary to operate its controlled end devices, resulting in a LIN bus system that has a reduction in parts.

In another aspect of the present invention, the communication network reduces latency and/or bandwidth requirements on a LIN bus by employing a scheduling strategy based on an analysis of the entire LIN bus topology.

In another aspect of the present invention, the communication network reduces latency and/or bandwidth requirements by distributing programmable PoUCs evenly, or relatively evenly, across multiple LIN strings, so that the summed bandwidth required on any individual string during the range of operation is minimized.

In another aspect of the present invention, the communication network achieves a simplified wiring harness architecture adapted to minimize and/or optimize the weight contributed to the overall vehicle by the communication network, by employing the minimum required wire length and wire diameter throughout different locations in the system.

In another aspect of the present invention, PoUC systems design achieves a simplified wiring harness architecture adapted to minimize and/or optimize the weight contributed to the overall vehicle by the communication network, by employing the minimum required wire length and wire diameter throughout different locations in the system, and/or by utilizing a three-wire system (i.e., a power line, a LIN communication line, and a ground).

In another aspect of the present invention, PoUC systems design employs PoUCs adapted to match the requirements of the devices under its control by providing hardware-only PoUCs where applicable, by providing tailored programmable PoUCs elsewhere, and by tailoring input output (I/O) sections such that each PoUC is adapted to match the requirements of the devices under its control.

In another aspect of the present invention, the communication network provides the minimum functionality in terms of processing power, bandwidth, and the like, to achieve that which is needed to operate vehicle systems so as to comply with automotive requirements in terms of robustness, fault detection, and safety.

Other desirable features and characteristics will become apparent from the subsequent detailed description, the drawings, and the appended claims, when considered in view of this background.

### DESCRIPTION OF THE DRAWINGS

Non-limiting and non-exhaustive embodiments of the present invention are described with reference to the following drawings. In the drawings, like numerals describe like components throughout the several views.

For a better understanding of the present invention, reference will be made to the following Detailed Description, which is to be read in association with the accompanying drawings, which are incorporated in and constitute a part of this specification, show certain aspects of the subject matter disclosed herein, and, together with the description, help explain some of the principles associated with the disclosed implementations, wherein:

FIG. 1 illustrates a top, schematic view of exemplary vehicle CAN electronic components and system architecture, according to an embodiment of the present invention;

FIG. 2 illustrates a top, schematic view of exemplary vehicle LIN electronic components and system architecture, according to an embodiment of the present invention;

FIG. 3A illustrates a diagram of an exemplary hardware-only point-of-use controller, according to an embodiment of the present invention;

FIG. 3B illustrates a diagram of an exemplary programmable point-of-use controller, according to an embodiment of the present invention;

FIG. 4 illustrates a LIN system architecture, according to an embodiment of the present invention;

FIG. 5 illustrates a first LIN string, according to an embodiment of the present invention;

FIG. 6 illustrates a second LIN string, according to an embodiment of the present invention;

FIG. 7 illustrates a third LIN string, according to an embodiment of the present invention;

FIG. 8 illustrates a fourth LIN string, according to an embodiment of the present invention; and

FIG. 9 illustrates a fifth LIN string, according to an embodiment of the present invention.

### DETAILED DESCRIPTION

Non-limiting embodiments of the invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention. The drawings featured in the figures are provided for the purposes of illustrating some embodiments of the invention and are not to be considered as limitation thereto.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, not necessarily mechanically, and not necessarily electrically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

The present invention relates to vehicle communication network architecture comprising one or more integrated circuit devices for controlling a plurality of Local Interconnect Network (“LIN”) controlled nodes based on point-of-use controllers (“PoUC”), wherein each PoUC is adapted as a LIN slave, the PoUCs being distributed along one or more LIN strings. According to the present invention, the PoUC communication network employs low-latency, zone-oriented architecture. Conventional vehicle communication networks traditionally employ a function-oriented architecture, which groups end devices (e.g., motors, solenoids, lights switches, and/or sensors) by their function. In this way, a LIN string may be dedicated to vehicle door closure end devices (i.e., locks), which results in dedicating wiring per end-use type across the vehicle and leads to increased weight, cost, and complexity. Recently, zone-oriented vehicle communication networks have been used, which group end devices by their location. A conventional zone-based architecture typically employs a number of universal zone control units; here, a LIN string has a number of localized end devices controlled by a zone control unit placed near the area. Because the zone control unit is physically located within that “zone” of the vehicle, without regard to commonality of system function, the physical wiring requirements may be reduced, but the bandwidth requirements are significantly increased. Bandwidth requirements are increased, because the conventional LIN bus scheduling strategy yields a schedule built to periodically send and received each node's data and diagnostic frames based on the signaling periods defined for each node. This approach typically leaves unused bandwidth on the LIN bus, according to the number of nodes and each node's specified signaling requirements. Furthermore, conventional designs employ universal, over-sized zone controllers that serve a zone, irrespective of the specific end devices under control. While such zone control units may benefit from being interchangeable with other controls within the vehicle, i.e., a zone control unit is configured to serve a multiplicity of zones having different end devices, this strategy results in oversized zone controllers that leave unused bandwidth across the system. The result is that conventional zone-based architecture, as with conventional function-based architecture, leads to increased weight, cost, and complexity.

The low-latency, zone-oriented architecture contemplated herein employs zone-specific PoUCs which may be adapted for use as LIN slaves tailored to a specific set of end devices. In one aspect of the present invention, one or more zone-based PoUCs may include only what is necessary to operate its dedicated LIN string. In another aspect of the present invention, a LIN scheduler is employed that implements a scheduling strategy based on an analysis of an entire LIN bus topology, where an optimal schedule is determined and/or computed that allows each controlled node fair access to the bus, with minimum latency, consistent with the physical bandwidth constraints of the bus. The LIN scheduler interleaves the input/output (I/O) and diagnostic cycles of the transmit and receive protocol on the bus, thereby lowering latency to give each node fair access to the bus. Interleaving the input/output (I/O) and diagnostic cycles increases the bandwidth and advantageously reduces unused bandwidth across the entire vehicle on the LIN bus. The LIN scheduler according to the present invention represents an improvement over the LIN 2.2A standard protocol, which yields a schedule built to periodically send and/or receive each node's data and diagnostic frames based on the signaling periods defined for each node. This conventional approach may leave unused bandwidth on the LIN bus, depending on the number of nodes and their specified signaling requirements. Such unused bandwidth can represent unnecessarily long latencies for some signals. Unused bandwidth may further result in disadvantages of larger network communication systems and additional weight to the vehicle, which may shorten the range of the vehicle. Consequently, the improved communication network apparatus, system, and/or method of the present invention employing PoUCs represents an optimization that keep latency low, and/or as short as possible, while simultaneously reducing cost, complexity, and weight. The resultant LIN schedules, therefore, retain the deterministic, periodic nature of the conventional LIN specification, but guarantee that latencies are no larger than necessary.

Therefore, according to the present invention, a zone-based, vehicle communication network architecture is disclosed that minimizes weight, cost, and complexity, while providing an optimized functionality in terms of processing power, bandwidth, low latency, and the like, to achieve only that which is needed to operate vehicle systems. This system may be particularly adapted for use in an electric vehicle having on-board solar panels, wherein the weight of system components is a dominating factor in the vehicle design.

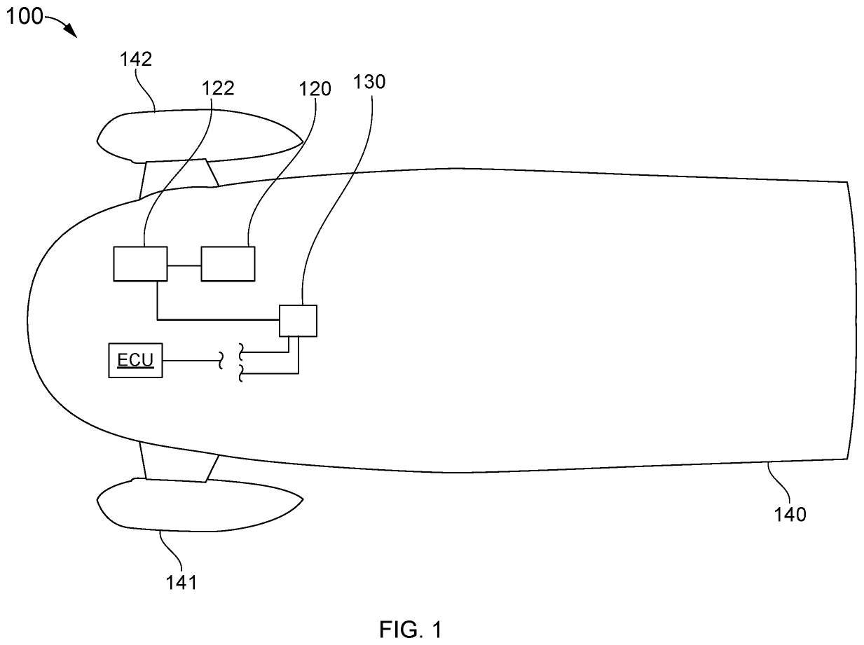

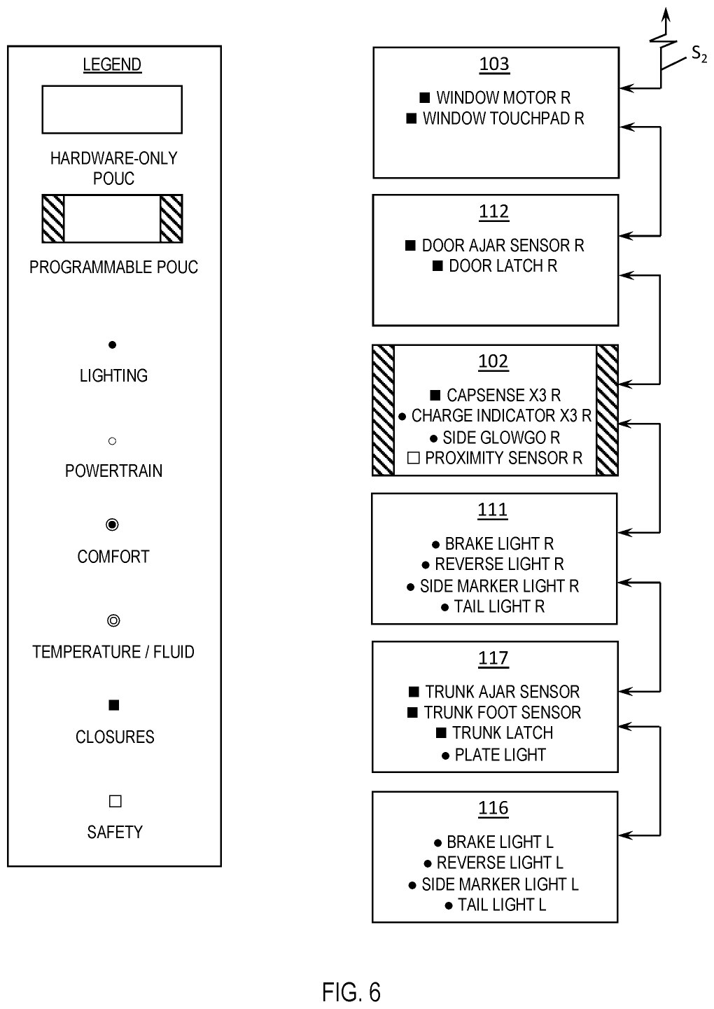

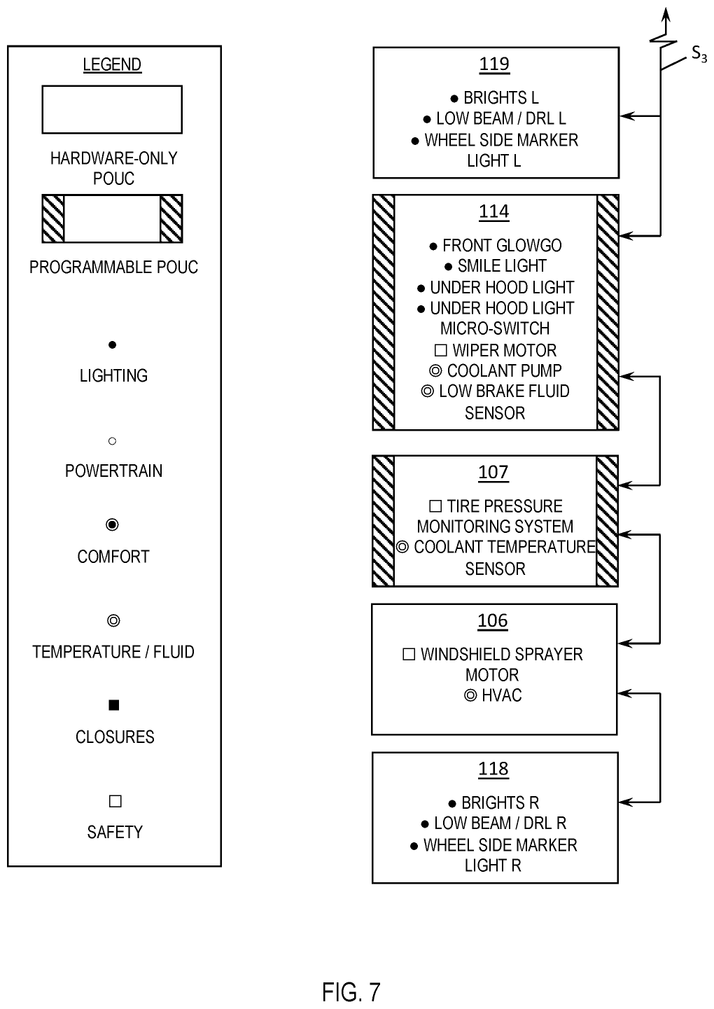

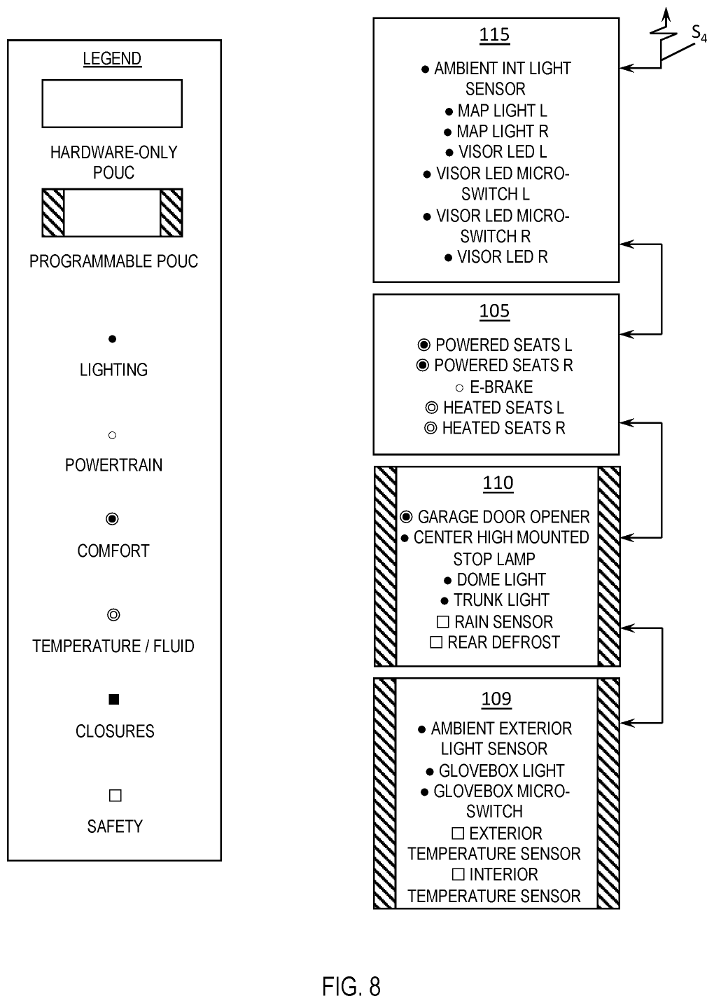

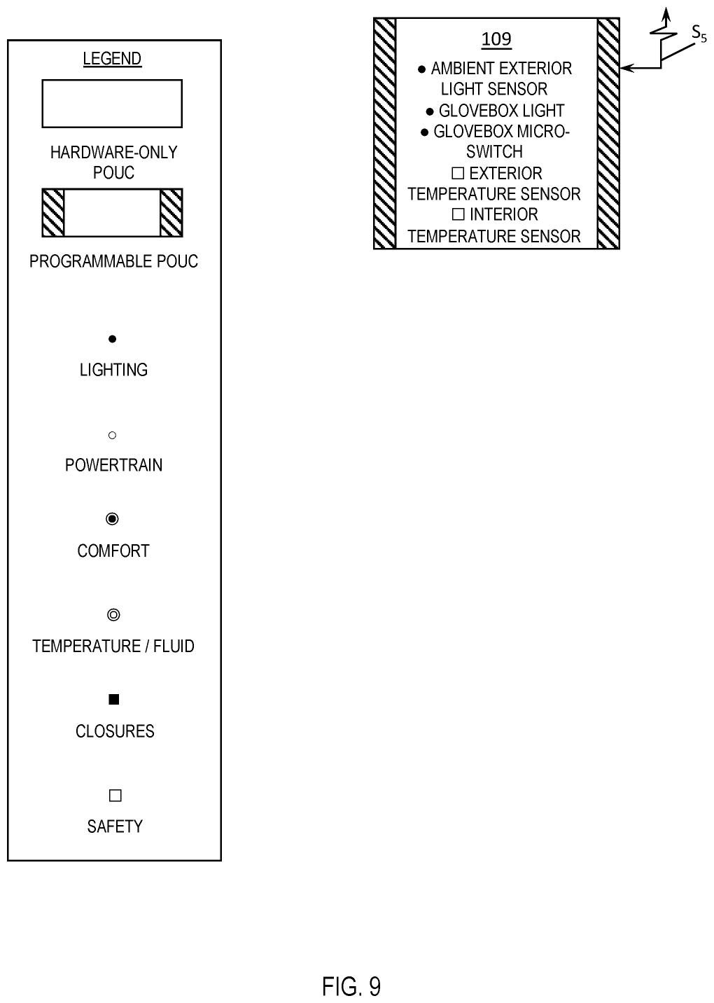

Referring to FIGS. 1-8, an exemplary vehicle communication network 100 is shown. The communication network may include controller area network (CAN) and local interconnect network (LIN) protocols. While any other protocol, and combination thereof, may be employed and is considered as falling within the scope of this disclosure, e.g., FlexRay, Ethernet, the LIN-based protocol employed at the PoUC level is considered to be the most desirable in terms of achieving a design that minimizes weight, cost, and complexity.

FIG. 1 illustrates an exemplary CAN bus including a gateway module 130 (herein referred to as “AGM”), that serve a variety of functions. As used herein, the term module refers to processing circuitry that may include an application specific integrated circuit (ASIC), an electronic circuit, a processor (shared, dedicated, or group) and/or memory that executes one or more software or firmware programs, a combinational logic circuit, and/or other suitable components that provide the described functionality. The AGM may execute master-driven tasks, such as cyclic task scheduling, maintaining a message and/or signal database, LIN I/O (PoUC I/O) scheduling, and test tasks to drive CAN bus heartbeat signals. A vehicle 140 may comprise a first wheel 141 and a second wheel 142 disposed in a forward direction, and a third wheel (not shown) disposed in a rearward direction. A system operation module 122 with a graphic user interface 120 (GUI) may be coupled to the AGM as shown. A CAN bus couples the system operation module and the AGM, so that messages can be passed therebetween, and also so that messages may be displayed on GUI 120 to convey information and process commands from a passenger of vehicle 140. A diagrammatic representation, “ECU”, may couple one or more additional CAN bus electronic control units to AGM 130; these may include, but are not limited to, powertrain components, battery components, solar charger components, and/or airbag controllers.

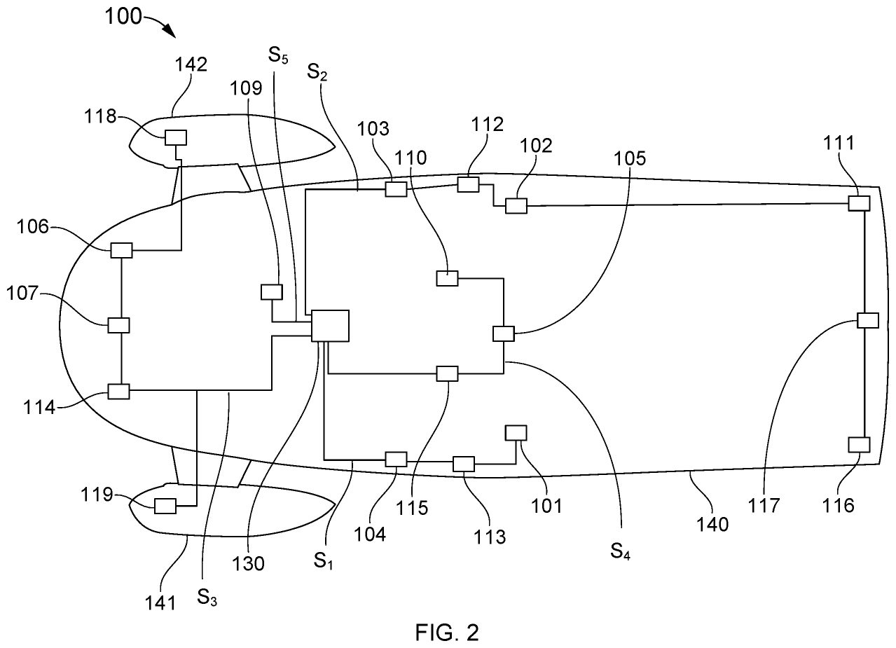

Referring now to FIG. 2, an exemplary LIN communication network is shown, in accordance with vehicle communication network 100, comprising a centrally-disposed gateway controller, AGM 130 and first, second, third, fourth, and fifth strings S₁, S₂, S₃, S₄, and S₅, respectively. The architecture shown reflects an optimized arrangement that minimizes length of wiring necessary across the LIN network, as well as physically coupling PoUCs on one or more strings in a manner that reduces latency according to the end devices served. The AGM does not incorporate any of its own device I/O; those functions are pushed out to the PoUCs. The system employs a plurality of PoUCs, shown here PoUCs 101-107, and 109-117, disposed locally according to the arrangement of end devices served in a manner that reduces overall weight. For example: first string S₁ may include PoUCs 104, 113, and 101; second string S₂ may include PoUCs 103, 112, 102, 111, 117, and 116; third sting S₃ may include PoUCs 119, 114, 107, 106, and 118; fourth string S₄ may include PoUCs 115, 105, 110, and fifth string S₅ may include PoUC 109. The PoUCs on each string S₁, S₂, S₃, S₄, and S₅ may be arranged serially as shown, or in a branched arrangement with respect to how they are coupled to the gateway controller AGM 130; furthermore, PoUCs may be individually branched on a single string, such as the exemplary arrangement of PoUC 119 shown with respect to PoUC 114.

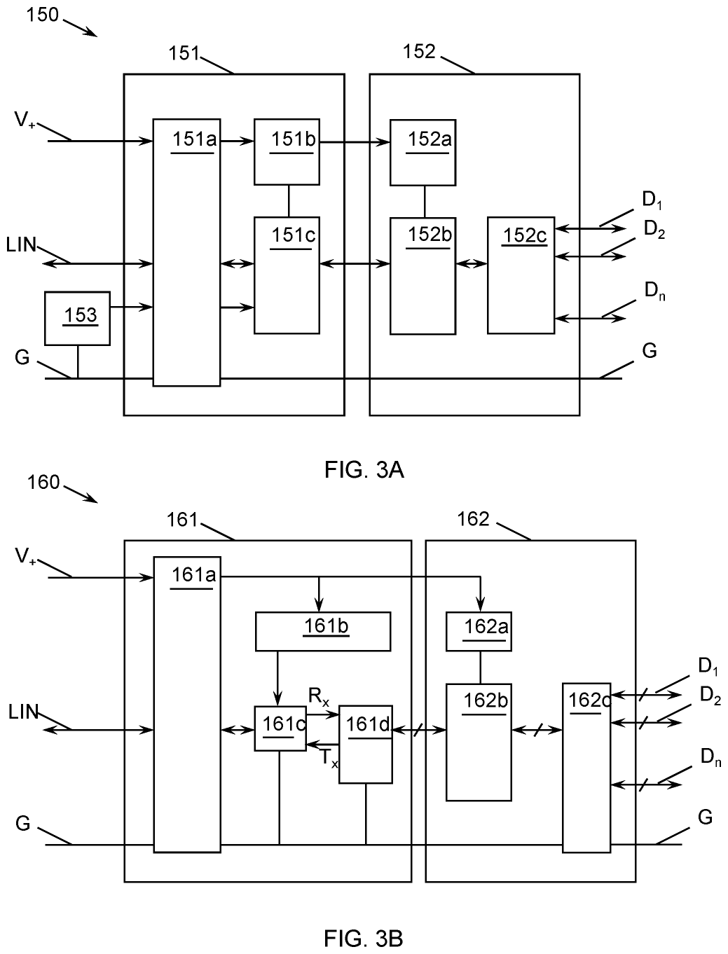

Turning now to FIGS. 3A and 3B, the point-of-use controllers are shown diagrammatically, wherein a hardware-only PoUC 150 is shown in FIG. 3A and a programmable PoUC 160 is shown in FIG. 3B. The LIN bus for which either PoUC 150 or PoUC 160 comprises a three-wire system including power (V+), a communication line (LIN), and ground (G) as shown. Each PoUC 150, 160, has a single interface to the vehicle communication network 100 three-wire system, wherein V₊ may supply 12V power to the PoUC and to the devices under its control. The 12V power V₊ and Ground G wires are sized to meet DC current requirements of the PoUC electronics and the devices under its control. The LIN wire is no larger than necessary to meet mechanical durability requirements. Requirements for PoUC 150, 160 I/O interface are determined by the characteristics of the devices under control; for example, FIGS. 3A and 3B show that PoUCs 150, 160 may include a Ground G, a first device D₁, second device D₂, up to an n^{th} device, Dₙ. Each PoUC is adapted to match the requirements of the devices under its control by providing tailored I/O sections (e.g., field effect transistor (FET) motor drivers to control motors, digital inputs to read contact closures). The I/O requirements further determine the overall size of PoUC 150, 160. Protection components 151a, 161a, 152c, 162c, may be disposed on either or both sides of PoUC 150, 160, i.e., at the three-wire system interface and the I/O interface, to provide protection from electrostatic discharge, over-voltage, short-circuit, and the like.

The hardware-only PoUC 150 eliminates the complexities associated with embedded device firmware; no software updates are required, and all the associated security and certification issues are avoided. The hardware-only PoUC 150 may comprise a hardware-only receiver module 151, which may include protection 151a, core module power 151b, and LIN controller 151c, and also an address jumper-ing connector (in connector) 153, as well as three-wire system interface. Hardware-only receiver module 151 may use, for example, the UJA1023 chip manufactured by NXP Semiconductors. PoUC 150 may further comprise a hardware-only device control module 152, which may include I/O power 152a, I/O control 152b, and protection 152c, wherein the control module 152 is tailored to the I/O requirements for a particular LIN string.

The programmable PoUC 160 may be an extension of the hardware-only PoUC 150, but may incorporate programmable elements for LIN strings when LIN latency or bandwidth constraints preclude the pure hardware approach. The programmable PoUC 160 may comprise a programmable core module 161, which may include protection 161a, LIN and core module power 161b, a physical layer 161c, and communication and control/status 161d, as well as three-wire system interface. Programmable core module 161 may use, for example, a Microchip ATTiny Series 0/1 family of 8-bit microcontrollers manufactured by Microchip Technology. Other implementations of the programmable PoUC 160 may be used that surface the purpose of providing a programmable element to implement the LIN protocol, diagnostics, firmware update, and functions required for the device under control via the tailored I/O interface. Programmable PoUC 160 may further comprise programmable device control module 162, which may include I/O power 162a, I/O control 162b, and protection 162c, as well as the tailored I/O interface.

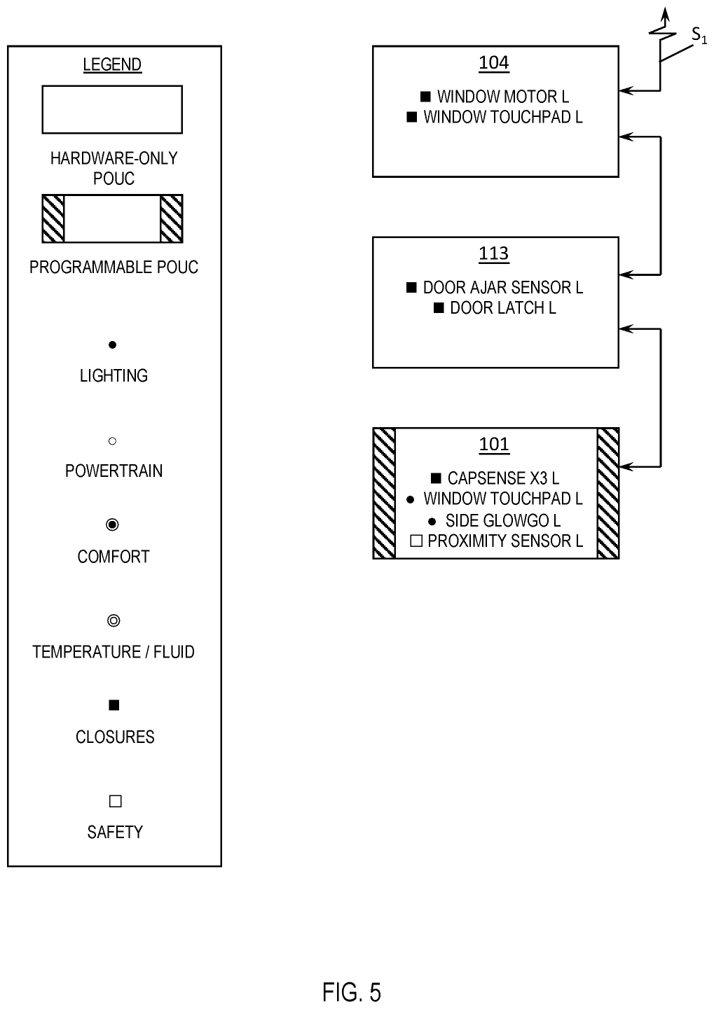

PoUCs 150 and 160 act as LIN bus nodes that implement application-specific features tailored to a particular string; therefore a PoUC 150 employed in one zone may be configured differently than a PoUC 150 employed in another zone. Similarly, a PoUC 160 employed in one zone may be configured differently than a PoUC 160 employed in another zone. Such variations may include: the number of I/O ports and corresponding end devices under PoUC control; the computation power of the processor; and the firmware or software loaded or pushed to a particular PoUC to implement tailored control of end use devices. As previously mentioned, for example, the I/O requirements for the end devices under control determine the overall size of a PoUC 150, 160. The core module 151, 161, may fit into an approximate 1 cm² PCB area, and the I/O hardware for low power devices may add approximately 2-3 cm² PCB area. Higher power devices may require more space, perhaps along with thermal management, such as a heat sink. PoUC 150 and/or 160 are adapted to interface with one or more peripheral devices, such as the I/O devices discussed herein with respect to FIGS. 5-8. In one embodiment, such I/O end devices may be arranged in a daisy-chained configuration with PoUC 150 or 160 at a central location. A PoUC 150 and/or 160 may support and host via, for example, the network architecture 100 of FIG. 2, a wide range of vehicular functions of mixed criticality. In some embodiments, PoUC 150, 160 may be integrated into the controlled end device as a weight, cost, and/or complexity saving measure. Consistent with these concepts, an objective of the tailored PoUC approach is to provide a vehicle communication network architecture 100 that minimizes weight, cost, and complexity, while simultaneously providing minimal latency.

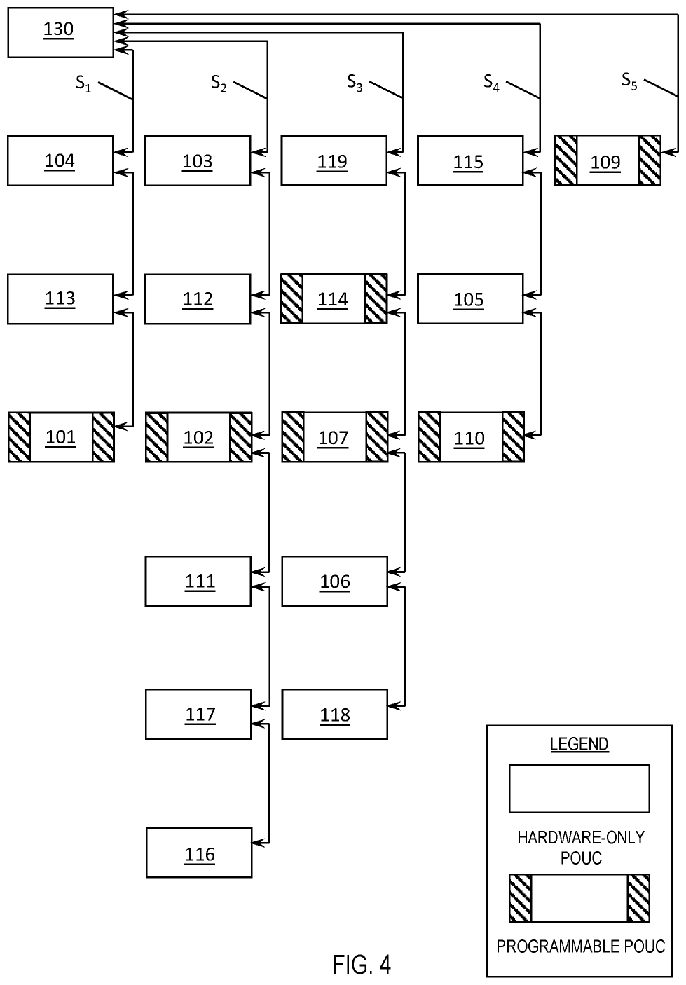

Now referring to FIG. 4 with reference to FIGS. 2, 3A and 3B, the vehicle communication network architecture 100 is shown downstream of the gateway controller 130 and in a diagrammatic manner, corresponding to the embodiment of the physical arrangement of FIG. 2. As in FIG. 2, first through fifth strings 51-55 may include one or more PoUCs as shown. According to the legend shown in FIG. 4, various PoUCs may be hardware-only PoUCs 150 such as that shown and described with respect to FIG. 3A, while various other PoUCs may be programmable PoUCs 160 such as that shown and described in FIG. 3B.

Referring to FIGS. 5-8, each of the first through fourth strings, S₁-S₄, are shown in detail with respect to exemplary end devices coupled thereto. As described herein, and as shown in the Legends of FIGS. 5-8 I/O end devices may generally be categorized, including but not limited to: lighting devices (e.g., head lights, floor lights, fog lights, brake lights, dashboard lighting, and similar vehicle components); powertrain devices (e.g., e-brake, brake actuators, speed sensors, and similar vehicle components); comfort devices (e.g., powered seats, garage door opener, and similar vehicle components); temperature/fluid devices (e.g., heating, ventilation, and air conditioning (HVAC), coolant pump, low brake fluid sensor, and similar vehicle components); closure devices (e.g., door or trunk locks, door or trunk ajar sensors, latch controls, and similar vehicle components); and safety devices (e.g., proximity sensors, wiper motors, tire pressure sensors, windshield sprayers, and similar vehicle components).

Therefore, expanding upon the arrangement embodied in FIGS. 2 and 4, a first string S₁ may comprise a PoUC 104 which may include a window motor L and a window touchpad L, a PoUC 113 which may include a door ajar sensor L and a door latch L, and a PoUC 101 which may include capsense x3 L, window touchpad L, side glowgo L, and proximity sensor L end devices. A second string S₂ may comprise a PoUC 103 which may include a window motor R and window touchpad R, a PoUC 112 which may include door ajar sensor R and door latch R, a PoUC 102 which may include capsense x3 R, charge indicator x3 R, side glowgo R, and proximity sensor R, a PoUC 111 which may include a brake light R, reverse light R, side marker light R, and tail light R, a PoUC 117 which may include a trunk ajar sensor, a trunk foot sensor, a trunk latch, and a plate light, and a PoUC 116 which may include a brake light L, a reverse light L, a side marker light L, and a tail light L end devices. A third string S₃ may comprise a PoUC 119 which may include a bright L, a low beam/DRL L, and a wheel side marker light L, a PoUC 114 which may include a front glowgo, a smile light, an under hood light, an under-hood light micro-switch, a wiper motor, a coolant pump, and a low brake fluid sensor, a PoUC 107 which may include a tire pressure monitoring system, and a coolant temperature sensor, a PoUC 106 which may include a windshield sprayer motor and HVAC, and a PoUC 118 which may include a bright R, a low beam/DRL R, and a wheel side marker light R end devices. Furthermore, a fourth string S₄ may include a PoUC 115 which may include an ambient int light sensor, a map light L, a map light R, a visor LED L, a visor LED micro-switch L, a visor LED micro-switch R, and a visor LED R, a PoUC 105 which may include a powered seat L, a powered seat R, an e-brake, a heated seat L, and a heated seat R, a PoUC 110 which may include a garage door opener, a center high mounted stop lamp, a dome light, a trunk light, a rain sensor, and a rear defrost end devices. And furthermore, a fifth string S₅ may include a PoUC 109 which may include an ambient exterior light sensor, a glovebox light, a glovebox micro-switch, an exterior temperature sensor, and an interior temperature sensor end devices. This arrangement is exemplary; any other suitable arrangement that is adapted to minimize weight, cost, and complexity of the vehicle communication network architecture 100 may be substituted and is considered within the scope of this disclosure.

Advantageously, in an exemplary embodiment, second string S₂ may be configured to perform functions typical of higher bandwidth buses, such as a CAN bus. For example, PoUC 111 and/or PoUC 116 may be programmable PoUCs 160, which incorporate a turn signal having a plurality of LEDs that operate according to a sequence. Such a sequence may be used to show turning direction via ON/OFF timing of the LEDs with respect to one another. Here, the vehicle communication network 100 according to the present invention employs tailored functionality that may serve a variety of desired effects, while maintaining minimal weight, cost, and complexity.

Embodiments of the vehicle communication network architecture 100 shown and described herein may be a system, a method, and/or a computer program product at any possible technical detail level of integration. The computer program product may include a computer readable storage medium (or media) having computer readable program instructions thereon for causing a processor to carry out aspects of the embodiments herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc (CD) ROM, a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments herein may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely within the vehicle and may be updated periodically (i.e., pushed) as in manufacture updates and the like.

Aspects of the embodiments herein are described with reference to block diagrams of methods, apparatus, systems, and computer program products. It will be understood that diagram and/or representative physical layout can be implemented by, or work in conjunction with computer readable program instructions. Such computer readable program instructions may reflect a technical improvement to the vehicle communication network architecture. Vehicle communication network 100 may utilize a LIN bus scheduling strategy, such as the LIN Specification Package, Revision 2.2A, published by the LIN Consortium. This method yields a schedule build to periodically send/receive each node's data and diagnostic frames, based on the signaling periods defined for each node. This method further leaves unused bandwidth on the LIN bus, depending on the number of nodes, and their specified signaling requirements. Unused bandwidth represents unnecessarily long latencies for some signals. The scheduling strategy employed herein is based, instead, on an analysis of an entire LIN bus topology. An ideal schedule is computed that allows each node (i.e., end device) fair access to the bus (e.g., strings S₁ through S₅), with minimum latency, consistent with the physical bandwidth constraints of the bus. The resultant LIN schedules retain the deterministic, periodic, nature of the conventional approach, but guarantee that latencies are no larger than necessary. In an additional aspect, to keep the I/O latencies as short as possible and/or practical, the LIN scheduler may interleave I/O and diagnostic cycles to the microchip, where applicable, in the PoUC.

These computer readable program instructions may be provided to a processor of a general-purpose computer, special purpose computer, or other programmable data processing apparatus to produce a machine, such that the instructions, which execute via the processor of the computer or other programmable data processing apparatus, create methods for implementing the functions/acts/capabilities specified in the diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts/capabilities specified in the diagrams.

The diagrams in FIGS. 1-8 illustrate the architecture, functionality, and operation of possible implementations of systems, methods, and computer program products according to various embodiments. In this regard, each diagram may represent a module, segment, or portion of instructions, which comprises one or more executable instructions for implementing the specified logical function(s).

The previous description of the disclosed embodiments is provided to enable any person skilled in the art to make or use the invention. Various modifications to these embodiments will be readily apparent to those skilled in the art, and the generic principles defined herein can be applied to other embodiments without departing from the spirit or scope of the invention. It is therefore desired that the present embodiments be considered in all respects as illustrative and not restrictive, reference being made to the appended claims as well as the foregoing descriptions to indicate the scope of the invention.

What is claimed is:

1. A LIN communication system for a vehicle comprising:
a gateway module coupled to one or more LIN strings, the gateway module adapted to execute master-driven tasks using a LIN scheduler,
wherein each LIN string of said one or more LIN strings includes:
one or more hardware-only point-of-use controllers including a hardware-only receiver module adapted to receive electronic messages from said gateway module, and a hardware-only device control module adapted to control one or more end devices through a tailored input/output section; and/or
one or more programmable point-of-use controllers including a programmable core module adapted to receive electronic messages from said gateway module, and a programmable device control module adapted to control one or more end devices through a tailored input/output section,
wherein each point-of-use controller of said one or more hardware-only point-of-use controllers and/or said one or more programmable point-of-use controllers is centrally-disposed with respect to the location of said one or more end devices, so that said LIN communication system comprises an optimized arrangement that minimizes the length of wiring necessary across the LIN communication system, thereby reducing the overall weight of the system.

2. The LIN communication system for a vehicle according to claim 1, wherein said LIN scheduler is adapted to interleave input/output (I/O) and diagnostic cycles.

3. The LIN communication system for a vehicle according to claim 1, wherein said hardware-only receiver module further comprises a protection, a core module power, a LIN controller, and an address jumper-ing connector.

4. The LIN communication system for a vehicle according to claim 1, wherein said hardware-only device control module further comprises an input/output (I/O) power, an I/O control, and a protection.

5. The LIN communication system for a vehicle according to claim 1, wherein said programmable core module further comprises a protection, a LIN and core module power, a physical layer, and a communication and control-status.

6. The LIN communication system for a vehicle according to claim 1, wherein said programmable device control module further comprises

7. The LIN communication system for a vehicle according to claim 1, wherein said device control module further comprises an input/output (I/O) power, an I/O control, and a protection.

8. The LIN communication system for a vehicle of claim 1, wherein said vehicle is an electric vehicle having on-board solar panels.

9. The LIN communication system for a vehicle of claim 1, wherein the one or more programmable point-of-use controllers and/or the one or more hardware-only point-of-use controllers on each LIN string of the one or more LIN strings are arranged serially.

10. The LIN communication system for a vehicle of claim 1, wherein the one or more programmable point-of-use controllers and/or the one or more hardware-only point-of-use controllers on each LIN string of the one or more LIN strings are arranged in a branched arrangement.
